(19) United States
(12) Patent Application Publication
(10) Pub. No.: US 2003/0061352 A1
(43) Pub. Date: Mar. 27, 2003

(54) Optimized file cache organization in a network server

(75) Inventors: Patrick Joseph Bohrer, Austin, TX (US); Elmootazbellah Nabil Elnozahy, Austin, TX (US); Thomas Walter Keller JR., Austin, TX (US); Ramakrishnan Rajamony, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY (US)

(21) Appl. No.: 09/965,009

(22) Filed: Sep. 27, 2001

(51) Int. Cl. G06F 15/16; G06F 15/173

(52) U.S. Cl. 709/226; 709/203

(57) ABSTRACT

A data processing server and method in which the server device stores a first fragment of a requested file in a first tier of storage while retaining subsequent fragments of the file in a lower tier of storage. The first tier is typically the server's volatile system memory while the second tier may represent a local disk, a networked storage device, or a remote system memory. When the server receives a client request for a file, the server transmits a first fragment of the file stored in the file cache to the client. Simultaneously, the server retrieves a subsequent fragment of the file from a lower tier of storage. By the time the first fragment is transmitted and acknowledged, the subsequent fragment is ready for transmission. In this manner, the server is able to maintain responsiveness while minimizing the amount of data cached in valuable system memory.

### BACKGROUND

1. Field of the Present Invention

The present invention generally relates to the field of network computing and more particularly to a method and system for improving server performance by storing a first portion of a data object in a first tier of storage while storing the remaining portions of the document in a second or lower tier of storage.

2. History of Related Art

In the field of networked computing and data processing, network server devices are commonly used to provide network services. The server device may comprise a portion of a server cluster that includes multiple, interconnected server devices, each of which is capable of processing server requests. The cluster may be configured to route incoming requests to an appropriate server device for processing. Requests may be distributed to individual server devices based upon the current loading of the individual servers, the origin of the request, the requested file or data, or other appropriate factors.

When a request for a file, document, or other data object is received by a server device, the server device determines whether the requested data is currently stored within the server device's system memory. Typically, a portion of system memory, referred to herein as the file cache or disk cache, is allocated to and used for storing copies of recently accessed data objects on the theory that recently accessed objects are likely to accessed again. Request handling performance is improved if the server device is able to retrieve the requested data from its file cache rather than retrieving the data from a second tier of storage such as a disk.

Unfortunately, system memory is scarce and expensive relative to disk storage. Although it would be desirable from a purely performance perspective to retain a copy of all requested data in the file cache, doing so would require a cost prohibitive amount of system memory. Therefore, only a portion of the data that is stored on disk is permitted to reside on the file cache at any given moment. In a conventional server device implementation, recently accessed data objects are retained in a file cache that has a maximum storage capacity or size. When the amount of data stored in the file cache approaches the cache capacity, existing cache data must be purged before new data can be stored in the cache. It would be desirable to implement a method or protocol that improved the utilization of scarce system memory of a server device without increasing the size or cost of the cache.

### SUMMARY OF THE INVENTION

The problems identified above are addressed by a data processing network and method in which a server device stores a first portion or fragment of a requested data object in a first tier of storage while retaining subsequent portions of the data object in a second or lower tier of storage. The first tier of storage is presumably faster and more expensive than the second tier. The first tier is typically the server's volatile system memory while the second tier may represent a local disk, non-volatile networked storage, or a remote system memory. When the server receives a request for a data object from a client, the server determines whether the first fragment of the requested data is present (and valid) in its file cache. If the first fragment is valid in the file cache, the server may format the fragment as one or more network packets and transmit the packet or sequence of packets to the client. While the transmission of the first fragment is occurring, the server retrieves a subsequent fragment of the requested data object from a lower tier of storage such as a local disk, networked storage, or the system memory of another server. By the time the first fragment is transmitted to the client and the server receives acknowledgement from the client, the subsequent fragment is residing in the first tier of storage and is ready for transmission. In this manner, the server is able to achieve a desired level of performance (i.e., responsiveness) while minimizing the amount of data cached in valuable system memory.

### BRIEF DESCRIPTION OF THE DRAWINGS

Other objects and advantages of the invention will become apparent upon reading the following detailed description and upon reference to the accompanying drawings in which:

FIG. 1 is a block diagram illustrating selected features of a data processing network;

FIG. 2 is a block diagram illustrating additional detail of the data processing network of FIG. 1;

FIG. 3 is a conceptualized representation of a first and second tier of storage in the network of FIG. 1; and

FIG. 4 is a flow diagram illustrating operation of a server in the data processing network of FIG. 1.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention contemplates a system and method for improving system memory allocation in a network server device and, more specifically, for managing the server device file cache by storing only a portion or fragment of a cached file in the actual file cache while storing the remainder of the file or data in a lower tier of storage. The file cache typically comprises a portion of the server's volatile system memory while the lower tier of storage is typically a slower and less expensive form of storage. The fragment retained in the file cache may include data for one or more network packets

A portion of the server device's system memory is designated as a file cache used to improve the server's responsiveness to client requests. The server device uses the file cache to store portions of files or other data objects that have been recently retrieved and/or calculated by the server. A server device according to the present invention stores a first fragment of a cached file in its file cache while storing the remainder of the file in a lower tier of storage. When a client requests a cached file from the server device, the server device responds by retrieving the first fragment of the file from the file cache and transmitting it to the client over the network. While the first fragment is being transmitted to the client, the server device can retrieve subsequent fragments of the requested file from the lower tier or tiers of storage. By the time the first fragment has been transmitted by the server device and acknowledged by the client, the next fragment is present in system memory and ready for transmission. By storing fragments of files in the file cache, the server device is able to conserve scarce system memory resources and thereby increase the number of files whose fragments can be cached in a given quantity of system memory. Server performance (i.e. responsiveness) is thus improved.

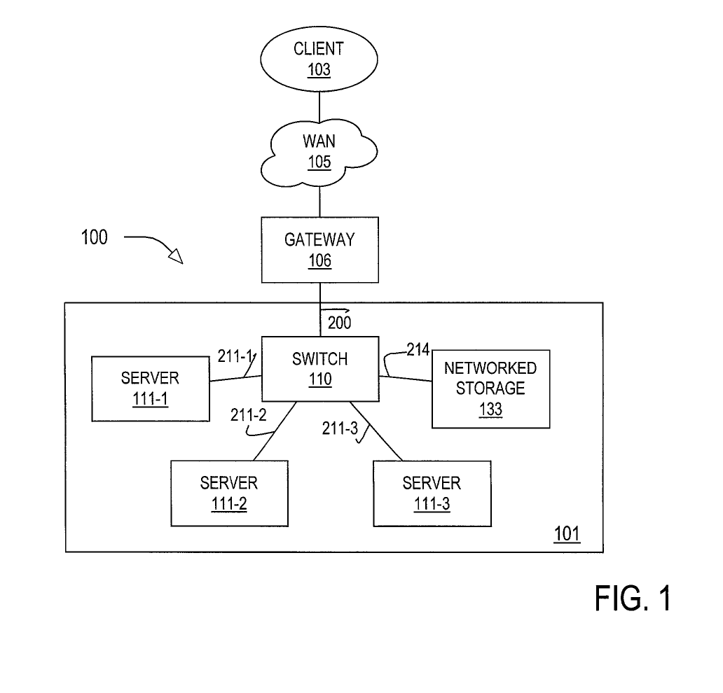

Before discussing details of a server device in accordance with the invention, a data processing network of which the server device may comprise a portion is presented to provide a context for the discussion of the server. Turning now to the drawings, FIG. 1 is a block diagram of selected features of a data processing network 100 that includes a server device according to one embodiment of the present invention. In the depicted embodiment, data processing network 100 includes a local area network (LAN) identified herein as server cluster 101 that is connected to a wide area network (WAN) 105 through an intermediate gateway 106. WAN 105 may include a multitude of various network devices including gateways, routers, hubs, and so forth as well as one or more other LANs all interconnected over a potentially wide-spread geographic area. WAN 105 may represent the Internet in one embodiment.

The depicted embodiment of server cluster 101 illustrates a point-to-point configuration in which server devices 111-1, 111-2, and 111-3 (generically or collectively referred to herein as server device(s) 111) are each connected to a switch 110 via a corresponding link 211. Server cluster 111 may further include networked storage 133 as discussed in greater detail below.

In an increasingly prevalent implementation, server cluster 101 services all client requests to a particular universal resource indicator (URI) on network 100 such that client requests to the URI originating from anywhere within WAN 105 are routed to server cluster 101. Switch 110 of cluster 101 routes client requests to one of the server devices 111 using any of a variety of request distribution algorithms to optimize server cluster performance, minimize cluster operation costs, or achieve some other goal. Switch 110 may route a client request to a server 111 based on factors such as the current loading of each server 111, the source of the client request, the requested content, or a combination thereof.

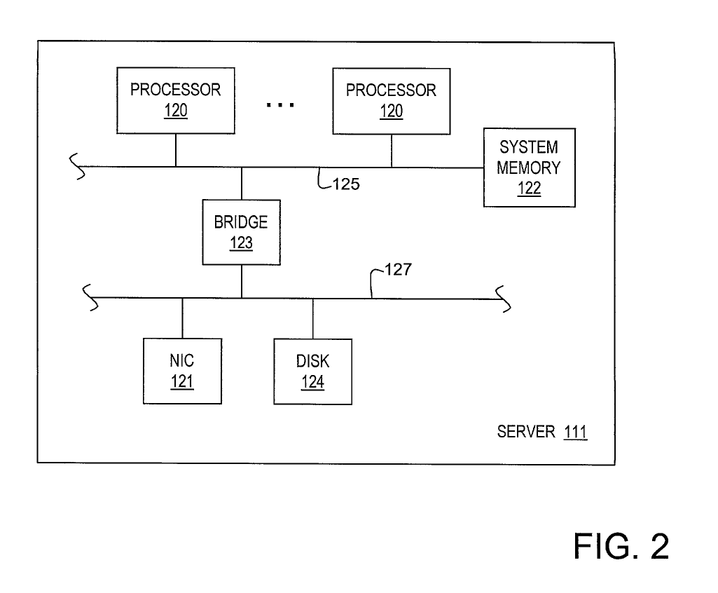

Referring now to FIG. 2, a block diagram illustrating selected features of a server device 111 is presented. Server device 111 includes one or more general purpose microprocessor(s) 120 connected to a system memory 122 via a system bus 125. System memory 122 typically represents the server's dynamic random access memory (DRAM) or other volatile storage structure. System memory 122 is referred to herein as the server's first tier of storage. (The processor's internal or external physical cache memory is disregarded in this classification scheme). The first tier of storage is typically characterized by a relatively high cost/byte and a relatively low access time relative to other forms of storage available to server device 111. Similarly, subsequently lower tiers of storage are characterized by a decreasing cost/byte and an increasing access time.

The depicted embodiment of server 111 further includes a bus bridge 123 that connects processor 120 to a peripheral bus 127, such as a Peripheral Components Interface (PCI) bus. A NIC 121 that connects server 111 and processor(s) 120 to an external network such as the server cluster 101 depicted in FIG. 1 is connected to peripheral bus 127. In addition, the depicted embodiment of server 111 includes a local, non-volatile storage device or disk 124 although this component is not required of server 111 and may be omitted to save cost in LAN configurations that provide non-volatile storage via the network.

Networked storage 133 of FIG. 1 represents a non-volatile storage element that is available to each server 111 of server cluster 101. Networked storage 133 may include a Network Attached Storage (NAS) box, a Storage Area Network (SAN), or a combination of the two. For purposes of this disclosure, these non-volatile storage devices, whether local to a particular server 111 or shared across server cluster 101, are referred to generally as a lower tier of storage to distinguish them from the first tier of storage represented by system memory 122. More generally, the lower tiers of storage refers to storage other than the server's local system memory 122. Thus, the lower tiers of memory could include, for example, a remote system memory (i.e., the system memory of a different server 111 on cluster 101).

Server devices such as server device 111 typically transmit data to a requesting client as a sequence of one or more network packets. Each packet includes a payload comprising a portion of the requested data as well as one or more header fields depending upon the network protocol in use. In an embodiment where WAN 105 represents the Internet, for example, packets transmitted between server 111 and client 103 are typically compliant with the Transmission Control Protocol/Internet Protocol (TCP/IP) as specified in RFC 793 and RFC 791 of the Internet Engineering Task Force (www.ietf.org). In addition to other parameters, network protocols such as TCP/IP typically limit the maximum size packet that the network can accommodate. IP, for example, typically limits network packets to a size of less than 2 KB. Moreover, the number of packets that can be transmitted from a server to a client in any single transmission burst is limited by parameters associated with the client-server connection. TCP connections define a first window specified by the client and a second window specified by the server that limit the number of packets that can be sent over the connection in a single transmission burst. See RFC 2001, TCP Slow Start, Congestion Avoidance, Fast Retransmit, and Fast Recovery Algorithms (IETF 1999). The first window reflects the limited buffer capacity of the client while the second window reflects network congestion, which can further limit that amount of data that the server can transmit reliably. Thus, sending large files over the network typically requires multiple transmission bursts from the server to the client.

When a large file stored in a file cache is sent to a client, only a portion or fragment of the file is sent to the client with each transmission burst while the remainder of the file just sits in the cache occupying valuable system memory. Moreover, in most environments, a server device is able to retrieve data from even its slowest tier of storage at least as fast as it is able to complete a transmission to a remote client over a wide area network such as the Internet and receive an acknowledgment back from the client. This suggests that there is no performance or responsiveness benefit obtained by retaining the entire file in the file cache. The present invention contemplates managing a server file cache by keeping only a first fragment of a large file in the file cache while the rest of the file is stored in lower tier(s) of storage. If the file is requested by a client, the first fragment can be transmitted directly from the file cache. Before the transmission of the first fragment is complete, the server can retrieve subsequent portions of the file from the less expensive tiers of storage thereby conserving the allocation of valuable system memory.

Portions of the present invention may be implemented as a computer program product comprising a set of computer executable instructions stored on a computer readable medium. The computer readable medium in which the instructions are stored may include volatile storage elements such as the system memory 122 of server 111. Alternatively, the instructions may be stored on a floppy diskette, hard disk, CD ROM, DVD, magnetic tape, or other suitable persistent storage facility.

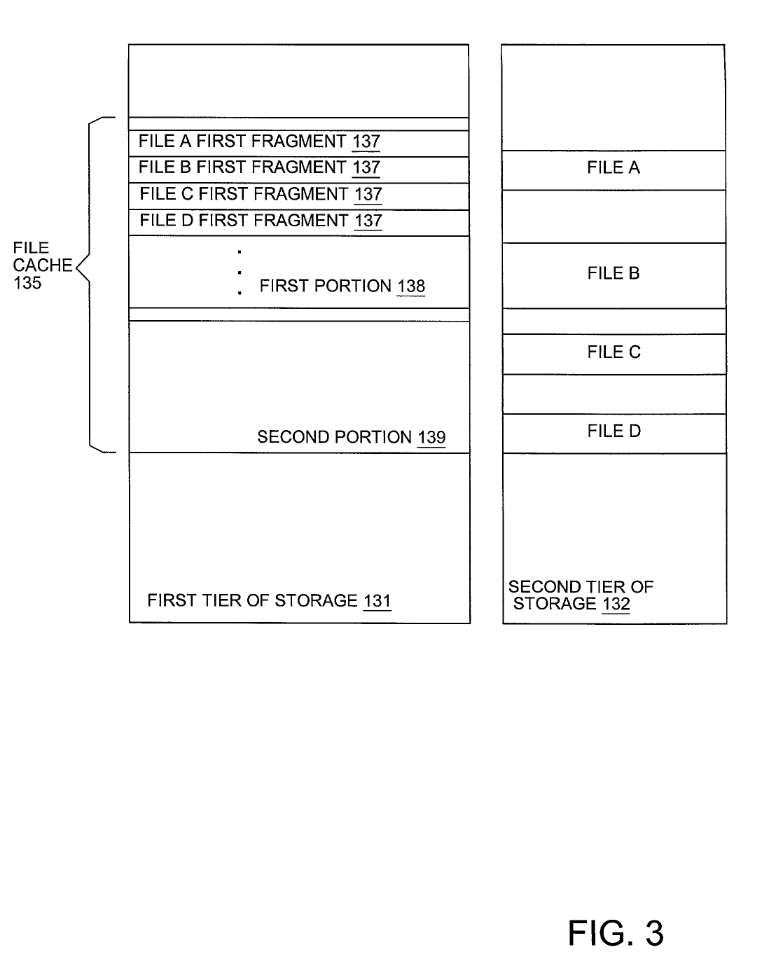

Referring now to FIG. 3, a conceptualized representation of multiple tiers of storage available to server 111 is shown. In this depiction, a first tier of storage 131, typically represented by system memory 120 of server 111, includes a file cache 135 used to store portions, referred to herein as first fragments 137, of recently accessed data. A second or lower tier of storage 132, which may represent a local disk 124, networked storage 133, a remote system memory, or a combination thereof, contains the remaining fragments of the files whose first fragments are stored in file cache 135.

Server 111 includes file cache management code that stores a first portion of a cached file in file cache 135 while retaining the remainder of the file in a lower tier (or tiers) of memory. Thus, file cache 135 may include a first fragment 137 of one or more data objects such as the first fragments 137 of the data objects identified as File A, File B, File C and File D in FIG. 3.

The ideal size of any first fragment 137 is governed by the desire to minimize the amount of system memory 120 consumed by file cache 135 and the competing desire to maintain a minimum level of system responsiveness. Smaller fragments consume less memory, but may result in reduced responsiveness if the server is not able to retrieve the subsequent fragments from lower tiers of storage before the first fragment has been transmitted and acknowledged.

In one embodiment, the size of first fragments 137 is roughly equal to the amount of data that can be reliably transmitted from server 111 in a single transmission burst. As indicated previously, the client-server connection establishes one or more limits on the amount of data that the can be transmitted in a burst over the connection before an acknowledgment is required. This limit is referred to herein as the transmission window. Server 111 preferably monitors its various client connections and their corresponding transmission windows. Server 111 may set the size of first fragments 137 in file cache 135 to accommodate the largest active transmission window. As subsequent client-server connections are opened and closed, the size of first fragments 137 may change to reflect changes in the largest active transmission window. Determining the size of first fragments 137 based upon the size of the largest transmission window guarantees a minimum level of server responsiveness regardless of the client requesting data while still substantially reducing the amount of system memory required for file cache 135. In a TCP environment, for example, the maximum transmission window is typically 64 KB and the actual transmission windows likely to be encountered in real client-server connections are typically significantly smaller than the maximum. In contrast, web pages and other files that are likely to be requested by a client now routinely exceed 1 MB. By allowing server 111 to store only a small fraction of large data files in its file cache 135, the invention has the potential to dramatically reduce the size of file cache 135, increase the number of files that are cached, or a combination of both without impacting responsiveness.

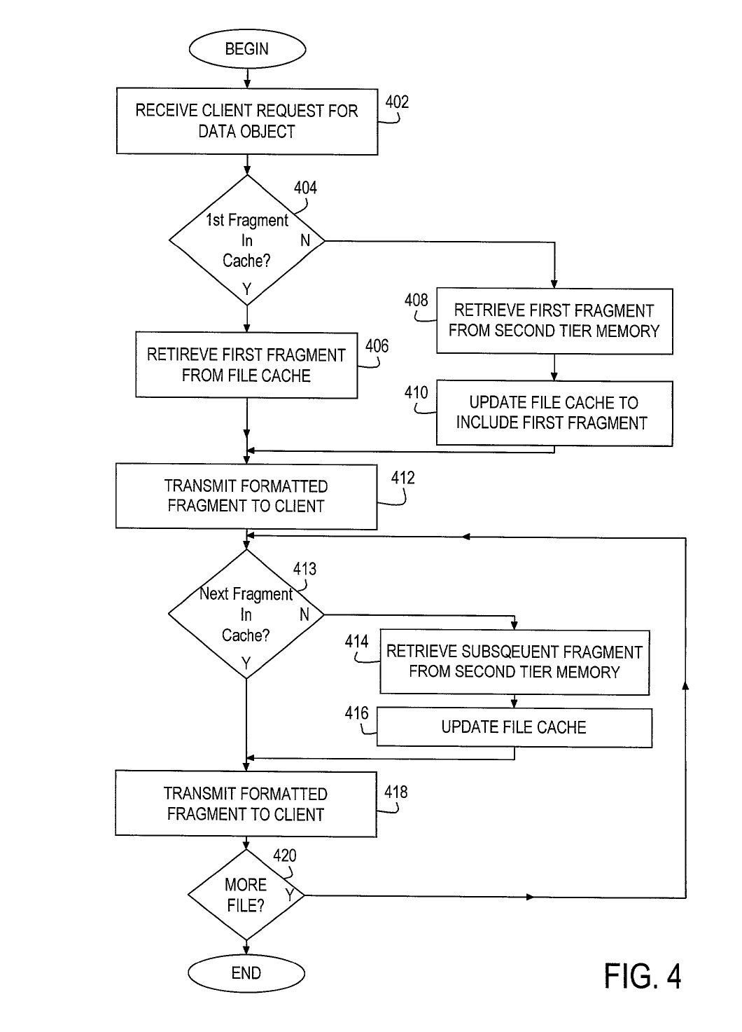

Turning now to FIG. 4, a flow diagram of a method of servicing client requests in a network environment according to one embodiment of the present invention is depicted. Initially, server 111 receives (block 402) a request for data from a client 103 and determines (block 404) if a first fragment 137 of the requested data is valid in file cache 135. The determination of whether a fragment is valid in file cache 135 may be facilitated by a file cache directory maintained by server 111 that includes information indicating the fragments 137 that are currently valid in file cache 135. If a first fragment 137 corresponding to the requested data is stored in file cache 135, server 111 will retrieve (block 406) the first fragment 137 from file cache 135.

If the first fragment of the requested data object is not in file cache 135, server 111 will retrieve (block 408) the first fragment from a lower tier of storage. The lower tier of storage may include a local disk 124 of server 111, a networked storage device 133, or a remote system memory 122 of another server 111 on server cluster 101. After retrieving the first fragment from the lower tier of storage, server 111 may update the contents of file cache 135 to include the first fragment 137 of the requested file. While the invention is not limited to a particular method of determining which files are cached, the updating of file cache 135 to include the retrieved fragment may proceed according to a least recently used criteria in which the newly retrieved fragment replaces the first fragment currently stored in file cache 135 that has been least recently accessed. This method implies maintaining in the file cache directory not only information identifying the content of file cache 135, but also information indicating when the respective files were most recently accessed. File server 111 may also decide not to cache a retrieved file in file cache 135 if, for example, the file is rarely requested. File server 111 may maintain a log of requested files and make a determination of which files are most frequently requested from the log information.

After retrieving the first fragment of the requested file from either the file cache 135 or second tier of storage, server 111 may perform (block 412) network processing to format or construct packets containing first fragment 137 as its payload and initiates transmission of the packet to client 103 over the network. The network processing may be omitted or substantially reduced in an implementation that uses pre-formatted packets as disclosed in the patent application of E. Elnozahy entitled, Processing of Requests for Static Objects in a Network Server, Docket No. AUS920010136US1, (serial 09/915,434 filed Jul. 26, 2001), which shares a common assignee with the present application. While the first sequence of packets is transmitting to client 103, server 111 determines (block 413) if the next fragment of the requested data is in file cache 135.

File cache 135 may include a first portion 138 that is dedicated for storing the first fragments 137 of various files and a second portion 139 that may be used to store subsequent fragments of one or more of the files whose first fragment is stored in first portion 138 of file cache 135. The size of file cache 135, first portion 138, and second portion 139 may all be dynamically altered by server 111 to optimize server performance.

If server 111 determines that the next fragment is not in the file cache 135, the fragment is retrieved (block 414) from the second tier of storage. The server 111 may then elect to store the subsequent fragment in file cache 135 and update (block 416) the file cache directory to indicate the presence of the fragment in the file cache. Whether the fragment was found in the file cache 135 or retrieved from second tier of storage, the fragment is then formatted if necessary and transmitted (block 418) across the network to the requesting client 103. Server 111 then determines (block 420) whether there are additional packets in the requested file to be transmitted. If the requested file has not been completely transmitted to the requesting client, the process repeats at block 413 until the entire file is transmitted.

The two tiered fragmentation of large files described above can be further expanded to encompass three or more tiers of storage. As an example, server device 111 may maintain a first fragment (a file cache fragment) of a file in its volatile system memory, a second fragment (a local disk fragment) of the file in its local disk, and the remainder of the file in networked storage. The local disk fragment is typically sufficiently large to contain multiple file cache fragments. As the file cache fragments in system memory are transmitted to the client, subsequent file cache fragments are retrieved from the local disk fragment. As the local disk fragment has been retrieved into system memory by the server, the server retrieves a subsequent local disk fragment from networked storage and repeats the process for this subsequent local disk fragment until the entire file has been transmitted. This extension of the basic invention thus conserves not only the first tier of storage (system memory), but also the second tier (local disk storage). Similarly, other implementations of three or more tiers of storage may be constructed.

It will be apparent to those skilled in the art having the benefit of this disclosure that the present invention contemplates a system and method responding to client requests in a server cluster environment by using a first tier of storage to store a first portion of data and a second tier of storage to store subsequent portions. It is understood that the form of the invention shown and described in the detailed description and the drawings are to be taken merely as presently preferred examples. It is intended that the following claims be interpreted broadly to embrace all the variations of the preferred embodiments disclosed

What is claimed is:

1. A method of processing a client request for a file, comprising:
transmitting a first fragment of the file that is stored in a first tier of server storage to the client;
retrieving a subsequent fragment of the file from a lower tier of storage while the first fragment is transmitting; and
after transmission of the first fragment completes, transmitting the subsequent fragment to the client.

2. The method of claim 1, wherein transmitting the first fragment includes retrieving the first fragment from a file cache of the server.

3. The method of claim 2, wherein the file cache includes a first portion in which the first fragment is stored, and further comprising storing the subsequent fragment in a second portion of the file cache.

4. The method of claim 2, wherein the file cache comprises a portion of the volatile system memory of the server.

5. The method of claim 1, wherein the lower tier of storage comprises at least one of a server disk device, a networked storage device, or a remote system memory.

6. The method of claim 1, further comprising, responsive to determining that a first fragment of the requested file is not valid in the first tier of storage, retrieving the first fragment from a lower tier of storage and storing the first fragment in the first tier.

7. The method of claim 6, further comprising determining a size for the first fragment based upon the transmission window of a connection between the server and client.

8. The method of claim 7, wherein the first fragment size is less than or equal to the maximum active transmission window of the server.

9. The method of claim 1, wherein transmitting the first fragment includes formatting the first fragment according to the transmission control protocol (TCP).

10. A server device, comprising:
a processor;
a system memory accessible to the processor and configured with instructions suitable for execution by the processor;
server code means for transmitting a first fragment of the file that is stored in a first tier of server storage to the client;
server code means for retrieving a subsequent fragment of the file from a lower tier of storage while the first fragment is transmitting; and
server code means for transmitting the subsequent fragment to the client after transmission of the first fragment completes.

11. The server device of claim 10, wherein the code means for transmitting the first fragment includes code means for retrieving the first fragment from a file cache of the server.

12. The server device of claim 11, wherein the file cache includes a first portion in which the first fragment is stored, and further comprising code means for storing the subsequent fragment in a second portion of the file cache.

13. The server device of claim 11, wherein the file cache comprises a portion of the server system memory.

14. The server device of claim 10, wherein the lower tier of storage comprises at least one of a server disk device, a networked storage device, or a remote system memory.

15. The server device of claim 10, further comprising, code means for retrieving the first fragment from a lower tier of storage and storing the first fragment in the first tier responsive to determining that a first fragment of the requested file is not valid in the first tier of storage.

16. The server device of claim 15, further comprising code means for determining a size for the first fragment based upon the transmission window of a connection between the server and client.

17. The server device of claim 16, wherein the first fragment size is less than or equal to the maximum active transmission window of the server.

18. The server device of claim 10, wherein transmitting the first fragment includes formatting the first fragment according to the transmission control protocol (TCP).

19. A computer program product residing on a computer readable medium for enabling a server device to process client requests, comprising:
server code means for transmitting a first fragment of the file that is stored in a first tier of server storage to the client;
server code means for retrieving a subsequent fragment of the file from a lower tier of storage while the first fragment is transmitting; and
server code means for transmitting the subsequent fragment to the client after transmission of the first fragment completes.

20. The computer program product of claim 19, wherein the code means for transmitting the first fragment includes code means for retrieving the first fragment from a file cache of the server.

21. The computer program product of claim 20, wherein the file cache includes a first portion in which the first fragment is stored, and further comprising code means for storing the subsequent fragment in a second portion of the file cache.

22. The computer program product of claim 20, wherein the file cache comprises a portion of volatile server system memory.

23. The computer program product of claim 19, wherein the lower tier of storage comprises at least one of a server disk device, a networked storage device, or a remote system memory.

24. The computer program product of claim 19, further comprising, code means for retrieving the first fragment from a lower tier of storage and storing the first fragment in the first tier responsive to determining that a first fragment of the requested file is not valid in the first tier of storage.

25. The computer program product of claim 24, further comprising code means for determining a size for the first fragment based upon the transmission window of a connection between the server and client.

26. The computer program product of claim 25, wherein the first fragment size is less than or equal to the maximum active transmission window on the server.
